(19) United States
(12) Patent Application Publication
(10) Pub. No.: US 2004/0065972 A1
(43) Pub. Date: Apr. 8, 2004

(54) Process for repairing a damaged vehicle body part employing a form

(76) Inventor: David T. Palazzo, Tampa, FL (US)

Correspondence Address: LARSON AND LARSON, 11199 69TH STREET NORTH, LARGO, FL, 33773

(21) Appl. No.: 10/264,734

(22) Filed: Oct. 4, 2002

(51) Int. Cl. B29C 73/00

(52) U.S. Cl. 264/36.22; 264/571; 264/219

(57) ABSTRACT

Preparing a form of a vehicle body part conforming to a corresponding damaged body part. Usually the form is prepared from a mold and a gasket is applied to an inner edge of the form. Drilling at least one vacuum port and at least one weep hole in the form. Applying a body putty to the damaged area of the body part and covering it with the form while exerting a vacuum to adhere the form to the body part while excess body putty exits from the weep hole. Removing the form after the body putty has hardened and painting the repaired body part.

### BACKGROUND OF THE INVENTION

The invention relates to a process for repairing damage to an automobile body part. More specifically, it refers to the preparation of a form of the body part and the use of the form to configure body putty over a damaged portion of the body part.

Modern vehicle body panels are made from very thin materials in order to make them lighter and more cost effective. Various shapes and contours are used in forming these thin panels in an attempt to make them hold their shape under variable conditions. This not only causes the panels to be more easily damaged, but makes them more difficult to repair.

Automobile and truck body panel damage has heretofore been repaired by first removing a dent and then applying polyester body putty to the damaged area. The body putty is then ground down to smooth the damaged area to the original shape and texture. Some vehicles have shapes and contours of body panels making it difficult to repair using these traditional methods. In many instances, the body panel is replaced by a new body panel. This puts unusual stress on insurance companies that in most instances must pay for vehicle damage repair.

In an attempt to make inexpensive repairs to damaged panels, a resonance damping vacuum blanket has been suggested as set forth in U.S. Pat. No. 5,575,165. A vacuum is pulled between damaged sheet metal and the damping blanket so that the damping blanket is secured to the sheet metal. An electromagnetic device is inserted through an access hole in the damping blanket and energized to pull the dent out of the sheet metal. Although this method can be used successfully on small dents, it cannot be successfully used on vehicle body panels having severe damage and several dents with cracks as occurs in many vehicle accidents. A need exists for a process that will lower the cost of automobile and truck panel damage.

### SUMMARY OF THE INVENTION

The present invention solves the problem of repairing damaged automobile and truck panels and eliminates the need to purchase replacement panels. The inventive process starts with preparing a form of the body part from an undamaged vehicle. A mold of an undamaged panel can be made using conventional mold making techniques. A suitable form is then made from the mold the body part and a gasket is applied to an inner edge of the form. At least one vacuum port is drilled in the form or body panel along with a weep hole for escape of body putty. Body putty is applied to the damaged area in conventional fashion and the form is pressed over the damaged body part. A vacuum is drawn so that the form adheres over the body putty to the damaged panel. Excess body putty exits through the weep hole. After the body putty hardens, the form is removed. The hardened body putty can be smoothed with fine grit and thereafter the body panel is painted.

### BRIEF DESCRIPTION OF THE DRAWINGS

The invention can be best understood by those having ordinary skill in the art by reference to the following detailed description when considered in conjunction with the accompanying drawings in which:

FIG. 1 is a perspective view of a damaged vehicle body panel.

FIG. 2 is a perspective view of a corresponding undamaged vehicle body panel.

FIG. 3 represents applying mold making material to the undamaged body panel of FIG. 2.

FIG. 4 is a perspective view of the mold prepared from the undamaged body panel of FIG. 2.

FIG. 5 is a bottom plan view of a body panel form as prepared from the mold of FIG. 4, the form having a gasket around an edge.

FIG. 6 is a top plan view of the body panel form of FIG. 5 with vacuum vent hole connections at each corner.

FIG. 7 is a perspective view of the damaged vehicle body panel of FIG. 1 with body putty applied to the damaged area.

FIG. 8 is a perspective view of the body panel form of FIG. 6 applied over the body panel with body putty applied as shown in FIG. 7.

FIG. 9 is a perspective view of the body panel form of FIG. 8 adhered to the damaged panel of FIG. 7 with body putty exiting from a weep hole.

FIG. 10 is a perspective view of the repaired body panel prior to painting.

### DETAILED DESCRIPTION OF BEST MODE

Throughout the following detailed description, the same reference numerals refer to the same elements in all the figures.

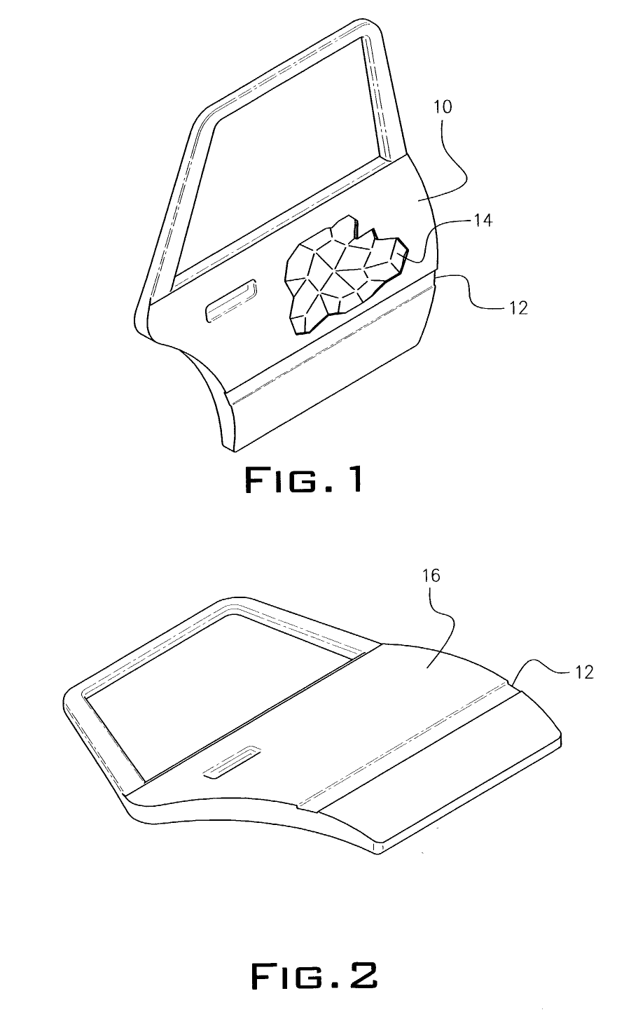

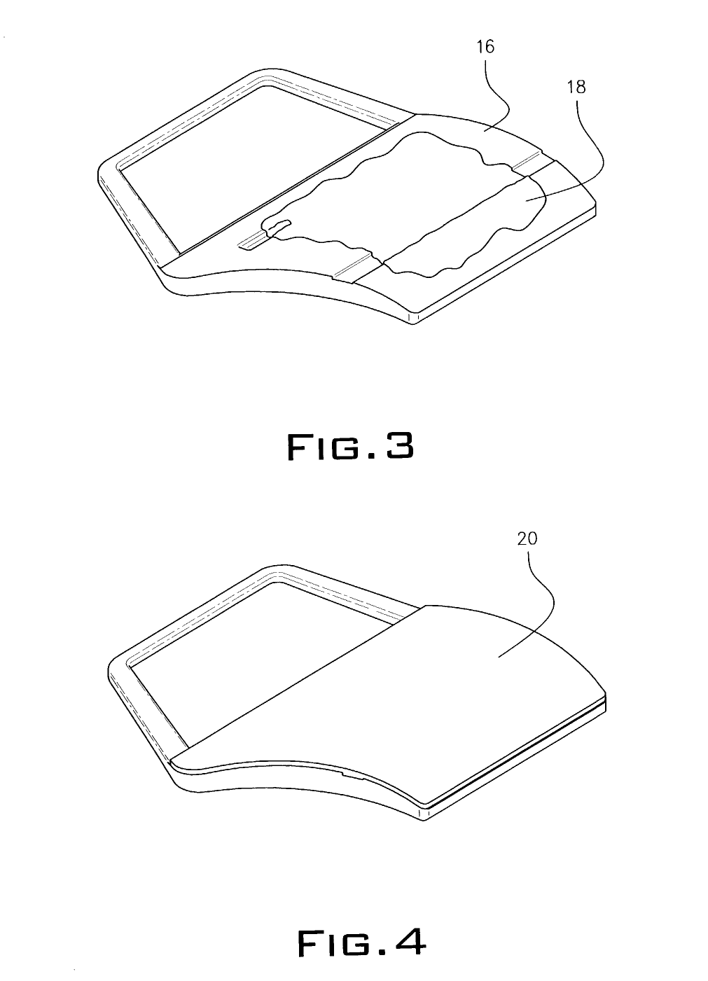

Referring to FIG. 1, a damaged vehicle panel 10 has a contour 12 and a damaged area 14. A corresponding undamaged vehicle panel 16 is shown in FIG. 2. The first step in the process of this invention is the preparation of a form of the undamaged vehicle panel usually from a mold formed by applying molding material 18 to the undamaged panel 16 as shown in FIG. 3. The molding material 18 can be a resin (thermoplastic or thermoset or other common molding material) well known in the prior art.

The form will conform exactly to the reverse shape of an undamaged panel or a section thereof. This can be accomplished in a number of ways that are commonly used in the molding and forming industry. Any method used to create a form which will provide suitable rigidity and conformance with the panel would be suitable for use in this invention. Use of a tool and die method to stamp out a form using a male and female die conforming to the shape of an object could be used. These forms can be made of various materials including steel and aluminum, as well as other formable materials.

The form also can be made by using resinous materials which can be applied to an undamaged panel and then removed after hardening. These resins can include various polyesters, epoxies, polyurethanes or other moldable materials commonly known to those in the molding industry. These resins can be used in conjunction with reinforcement materials which can include fillers, fibrous strands or fabrics and mats which add rigidity, strength and crack resistance. Core materials also may be used to provide rigidity. These can include balsa wood, honeycomb and various foams including polyurethane.

A release agent is generally applied to the body panel prior to application of the resinous material. This allows the part to be removed after the material hardens. These release agents can include waxes, silicones, polyvinyl alcohol or other releases commonly known in the molding industry.

Another method of producing a form is to first make a form as described above and then use that form/mold to make a master male plug (an exact duplicate of the face of the panel) which is then used to make multiple forms. This method could be used when it would be desirable to produce multiple copies of the same form.

Various methods can be used to produce molds, plugs or forms. These include any method generally known within the forming or molding industry to produce parts from a mold. These methods can include sheet forming, pre-preg, pre-form, spray-on, hand lay-up, metals, plastics, polymers, wood, rubber, glass, concrete, ceramics, or any other method or material which can be contoured to maintain the shape of the mold, plug or form. Any resin (thermoplastic or thermoset) can be used to make molds or forms.

Another method of making a mold is to use the actual panel as the master or plug. This is practical when it is unnecessary to use the panel for its original intended use. This method also saves the steps of making a mold from the panel and then making a master mold, or plug, which is then used to make the forms. The panel/plug may have to be modified to create draft (taper) around the periphery so that the form can be removed without difficulty.

Another method of producing forms would be computer aided design (CAD) in conjunction with machinery which is used to make forms and molds. These are methods which are commonly known and used within the manufacturing industry.

A polymeric thermoform 22 shown in FIG. 5 is made from mold 20. The polymeric thermoform 22 (hereafter form) can be made from sheet polycarbonate or other chemical resistant material that will not degrade when contacted with body putty. The form 22 is substantially ridged and conforms exactly to the reverse shape and contour 12 of the body panel 16. Wax or other mold release agent can be used on the mold 20 surfaces contacting the form 22 to inhibit sticking of the form 22 to the mold.

The form 22 can now be modified to make it suitable for its intended purpose. This may include the installation of vacuum ports 30, drains and sealing material 26 to be used between the form and the panel. Sealing material can be in the form of a rubber gasket surrounding the damaged area 14 of the panel or in the form of vacuum tape placed around the periphery 28 of the interface of form 22 and the panel 10. The vacuum ports 30 and sealing materials 26 can be positioned anywhere where they will provide a means to draw a vacuum between the form and the panel. Vacuum ports 30 can be positioned in the form 22 or the panel 10 or any place in between. The weep holes or drains 36, if necessary can be included in the form 22 or the panel 10. The drains 36 may be used to inject body putty 24 if the injection method of applying filler material between the form and the damaged panel is used.

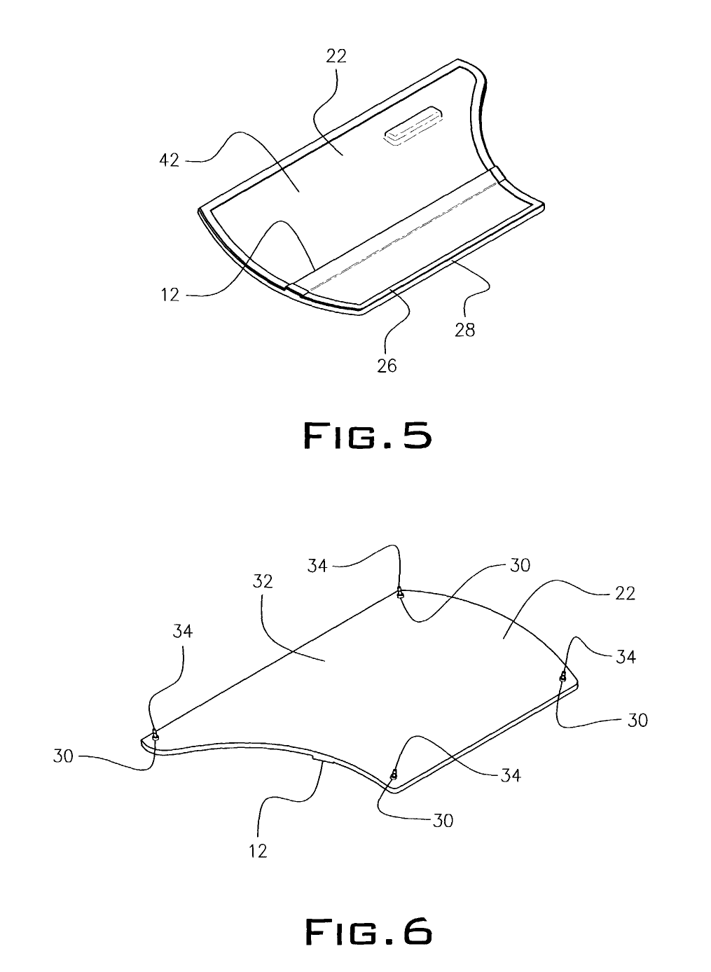

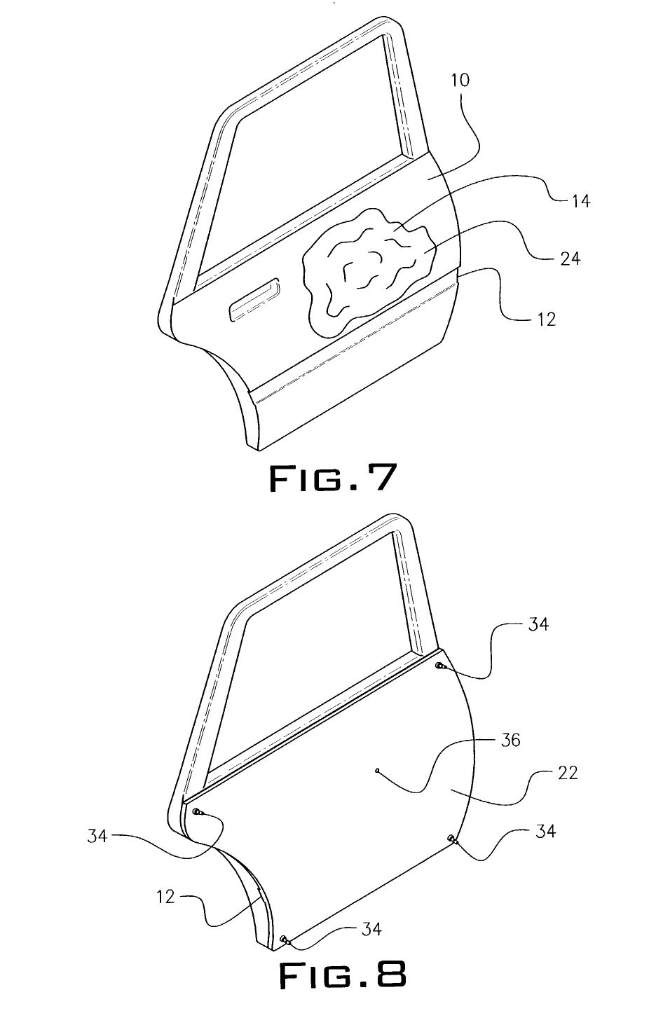

As seen in FIG. 6, vacuum vents 30 are drilled in a top portion 32 of form 22 and vacuum vent connectors 34 are inserted in holes 30. At least one vacuum vent 30 is required, but many more as shown in FIG. 6 can be drilled away from the damaged area of the panel. In addition, the weep hole 36 is drilled in form 22 in about the area of the panel damage as seen in FIG. 8. Body putty 24 is applied to the damaged area 14 of the body panel 10 as seen in FIG. 7. Body putty 24 alternatively can be injected between the panel and the damaged panel.

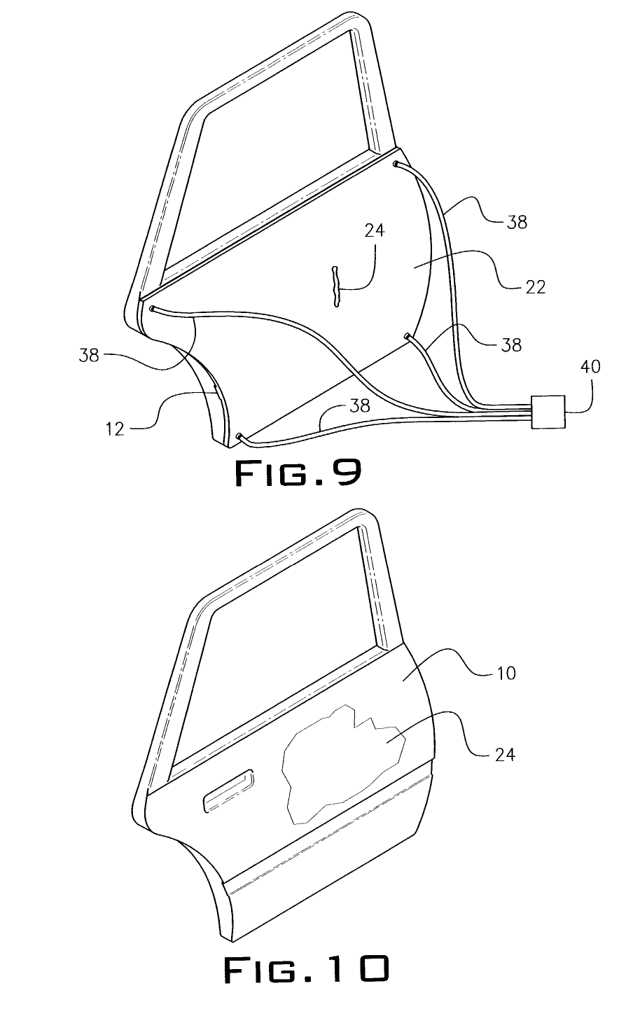

The form 22 as seen in FIG. 8 is applied over the damaged panel 10 and a vacuum taken with hoses 38 connected to a vacuum pump 40 as seen in FIG. 9. The form 22 then adheres firmly to damaged panel 10 and excess body putty 24 oozes out of weep hole 36. Additional weep holes 36 can be drilled, if needed. After the body putty 24 hardens, the form 22 is removed from the damaged panel 10 and can be trimmed to the desired configuration. The repaired panel is shown in FIG. 10.

The steps in the method of repairing a vehicle body part require the making of the form from the mold conforming exactly to the reverse shape of the undamaged panel. Subsequently, the steps of applying a gasket to the form, drilling one or more vacuum ports and a weep hole in the form can be done in any order. The body putty is applied to the damaged area of the body part just prior to applying the form to the body part and applying a vacuum to adhere the form to the body part.

If one were to use pressure alone on the form 22 to force the form into intimate contact with the panel 10, further damage would most likely occur to the panel. This is because the panel cannot generally support the necessary force required to compress the filler and the panel cannot normally be supported, from the back side, to counteract the force, due to lack of access to the back side of the panel

The vacuum creates equal force on the form as well as the back side of the panel, thereby forcing the panel into intimate contact with the form without substantially deforming the panel.

An alternate method that can be used is to apply body putty 24 to the damaged area 14 through a port in form 22 in place of weep hole 36. In this instance, a clear polymeric form can be employed to guarantee by visual observation that all voids between the inner surface 42 of the form 22 and the damaged area 14 are filled.

An advantage of this process is that the body filler 24 can be harder than the typical soft fillers since extensive grinding of the dried body filler is unnecessary. The harder fillers are less moisture absorptive and are less likely to cause “popups” in the finish. In addition, because grinding is negligible, the time to effect a repair to a damaged panel is reduced considerably.

Other equivalent steps or products employed can be substituted for the steps and products disclosed herein to produce the same results in the same way.

What is claimed is:

1. A method for repairing damage to a vehicle body part, comprising the steps of:
(a) preparing a suitable form of the body part;
(b) providing a seal along a bottom edge of the form;
(c) applying a filler between the form and a damaged vehicle body part;
(d) providing a weep hole to remove excess body putty;
(e) pressing the form over the damaged body part and drawing a vacuum through a vacuum port to adhere the form to the body part and causing excess filler to exit through the weep hole; and
(f) after the filler hardens, removing the form.

2. The method according to claim 1 wherein the form is made from a polymer.

3. The method according to claim 1 wherein the vacuum port is provided at each corner of the form.

4. The method according to claim 1 wherein the weep hole is an opening for inserting filler.

5. The method according to claim 1 wherein the hardened filler is smoothed with a fine grit and then the body panel is painted.

6. The method according to claim 1 wherein the seal is provided as a rubber gasket.

7. The method according to claim 2 wherein the polymer provided is polycarbonate.

8. The method according to claim 1 wherein the filler is provided as body putty.

9. A method for repairing damage to a vehicle body panel, comprising the steps of:
(a) first preparing a mold of the body panel from an undamaged body panel;
(b) secondly, preparing a suitable form from the mold of the body panel;
(c) thirdly, in any order, applying a sealing material to an inner edge of the form on a surface to be applied to the damaged body panel, providing at least one vacuum port in the form and providing at least one weep hole;
(d) fourthly, applying a filler between a damaged body part and the form and before the filler can harden, applying the form over the damaged body part and applying a vacuum between the form and body panel to adhere the form to the body panel; and
(e) lastly, after the filler hardens, removing the form.

10. The method according to claim 9 wherein the polymeric form is made by thermoforming.

11. The method according to claim 9 wherein the form is made from a polymer

12. The method according to claim 9 wherein four vacuum ports are provided, one in each corner of the polymeric form.

13. The method according to claim 9 wherein the hardened filler is smoothed with fine grit.

14. A method for repairing damage to a vehicle body part, comprising the steps of:
(a) preparing a mold of the body part from an undamaged vehicle;
(b) preparing a suitable polymeric form from the mold of the body part;
(c) applying a gasket to an inner edge of the polymeric form;
(d) drilling at least one vacuum port through the form;
(e) applying a body putty to a damaged body part;
(f) drilling a weep hole in the form over the body putty;
(g) pressing the form over the damaged body part and drawing a vacuum to adhere the form to the body part and causing excess body putty to exit through the weep hole; and
(h) after the body putty hardens, removing the form and smoothing the hardened body filler.

15. The method according to claim 14 wherein the polymeric form is made from polycarbonate.

16. The method according to claim 14 wherein the vacuum port is drilled at each corner of the form.

17. The method according to claim 14 wherein the weep hole is provided as a port for inserting body putty.

18. The method according to claim 14 wherein the hardened body filler is smoothed with a fine grit and then the body panel is painted.
